(19) United States
(12) Patent Application Publication
(10) Pub. No.: US 2024/0161050 A1
(43) Pub. Date: May 16, 2024

(54) A SYSTEM AND METHOD FOR RETURNING LOST PERSONAL ITEMS TO THEIR OWNERS

(71) Applicant: Aaron Joseph Johnson, Brisbane (AU)

(72) Inventor: Aaron Joseph Johnson, Brisbane (AU)

(21) Appl. No.: 18/552,648

(22) PCT Filed: Mar. 30, 2022
(86) PCT No.: PCT/AU2022/050286

§ 371 Date: Sep. 26, 2023

(30) Foreign Application Priority Data
Mar. 31, 2021 (AU) 2021900957

(51) Int. Cl. G06Q 10/083; G06F 16/2455; G06K 7/14; G06K 19/06; G08B 21/24

(52) U.S. Cl. CPC G06Q 10/083; G06F 16/2455; G06K 7/1417; G06K 19/06037; G08B 21/24

(57) ABSTRACT

A method for owner retrieval of important personal items or devices. The method includes inputting scanned code data into a database, the code data being from an affixable code-scannable tag affixed to the device; determining the owner of the device from the code data by matching the code data with owner data in a database; accessing an account associated with the owner that includes cost delivery costs of the device to an address associated with the owner of the device; and processing delivery of the device to the address in accordance with preconfigured delivery instructions associated with the owner of the device. The method may include determining geolocation of a supplemental owner device within a predetermined radius of the original, lost device to more accurately verify owner identity and presence, helping to ensure proper return of a lost device to an owner.

### FIELD OF THE INVENTION

The present disclosure relates to a system and method of using code-scannable tags to facilitate the return of lost electronic devices or other valuable personal items to their owner.

### BACKGROUND OF THE INVENTION

Some systems of returning lost electronic devices require the owner of the device to track down the device using “Find my phone” or other software. Such software only works while the electronic device has charge, or for a brief period after the electronic device runs out of charge. Other systems of returning lost electronic devices and other lost personal items require the finder of the item to return the device to a police station and for the owner of the device to contact the relevant police station. Many finders and owners may be reluctant to attend a police station, police stations are not always conveniently located, owners may not know which police station to contact or may contact the police station before the device is returned there. Other systems of returning lost electronic devices and other lost personal items require direct communication between the finder and the owner. People may be uncomfortable with such communication, it may not be desirable or safe to share the personal information required to facilitate return of the lost device with a stranger, and the finder may try to extort money from the owner in exchange for returning the device. Accordingly, there exists a need to provide a system to facilitate efficient retrieval of lost electronic devices and other lost personal items by their owner which lessens the problems of conventional systems.

It will be clearly understood that, if a prior art publication is referred to herein, this reference does not constitute an admission that the publication forms part of the common general knowledge in the art in Australia or in any other country.

### SUMMARY

The present disclosure in a preferred aspect has a machine readable code that is affixed to an item, such that when the finder of the lost item takes the item to a repository for a business identified on that machine readable code, a machine of the business can read the code and associate it with the data of the person who purchased that machine readable code or other person nominated by them which is stored on a database of the business or a third party associated with the business, and the data of the person is used to return the lost item to the person who purchased that machine readable code or other person nominated by them. The machine readable code may be any one or more of the following: a barcode; QR code; hologram; special symbol etched, engraved or lasered into the device; or a microdot with RFID technology.

The present disclosure in one aspect sets forth a system to facilitate efficient retrieval of any type of lost item such as: a wallet; a diabetes or anaphylaxis kit, or any other medical device; a pair of sunglasses, a watch or any other jewellery. The present disclosure in another aspect sets forth a system to facilitate efficient retrieval of lost electronic devices, such as: a mobile phone, headphones, a tablet computer, or a laptop computer. In this embodiment, it is an advantage of the system that it is not dependent upon whether or not the electronic device has charge. For example, in a preferred embodiment, a code-scannable tag is applied to the electronic device, which can be scanned by a scanner that inputs the scanned code data into a database of owner names and addresses, and no functionality or participation is required of the electronic device itself. This advantageously eliminates the need for the device to have any charge.

The present disclosure in another aspect sets forth a system to facilitate efficient retrieval of lost electronic devices and other lost personal items via a trusted intermediary. In particular, in a preferred embodiment, the finder returns the lost items to the post office, where the code-scannable tag on the device is scanned by a scanner, and then the device is posted to the address associated with that code-scannable tag. This advantageously eliminates the need for finders and owners to have direct communication or share personal information with each other.

The present disclosure in a further aspect sets forth a system to facilitate efficient retrieval of lost electronic devices and other lost personal items irrespective of the location of the repository to which they are returned or the delay before the lost personal items are returned.

The present disclosure in yet a further aspect facilitates retrieval of lost electronic devices by the finder, by providing convenient repositories that exist in multiple, neutral locations, reducing the logistical, psychological and other barriers that might otherwise reduce the rate of finder return of lost electronic devices. Such repositories may include, for example, Post Office boxes and Post Offices, and parcel carrier locations.

The present disclosure in one optional aspect facilitates payment of the cost to return the lost item up-front at the time of purchase of the code scannable tag. The prepayment made at the time of purchase of the code-scannable tag covers shipping nation-wide, and the name and address data entered into the database at the time of purchase of application of the code-scannable tag means the owner has taken all necessary steps to facilitate retrieval prior to loss of the device. To the advantage of the operator of the system, this option better provides that the running costs of the system are covered in advance, and minimises the administrative burden (and associated running costs) of chasing owners for payment. To the owner's advantage, this option speeds up the retrieval process and may also fix the price of retrieval at a rate that is lower than market rate for retrieval at the time the electronic device is lost (however, in one embodiment, the system may allow for a top up payment to be requested if the pre-payment is not sufficient to cover market rate for retrieval at the time the electronic device is lost).

It is to be understood that both the foregoing general description and the following detailed description are exemplary and explanatory only and are not restrictive of the invention, as claimed. In the present specification and claims, the word “comprising” and its derivatives including “comprises” and “comprise” include each of the stated integers, but does not exclude the inclusion of one or more further integers.

It will be appreciated that reference herein to “preferred” or “preferably” is intended as exemplary only. The claims as filed and attached with this specification are hereby incorporated by reference into the text of the present description.

The accompanying drawings, which are incorporated in and constitute a part of this specification, illustrate several embodiments of the invention and together with the description, serve to explain the principles of the invention.

### BRIEF DESCRIPTION OF THE FIGURES

FIG. 1 is a pictorial of a one dimensional bar code and a QR code.

FIG. 2 shows pictorials of five types of QR codes.

FIG. 3 shows a phone with a QR code attached to the phone by an adherent.

FIG. 4 shows a finder holding an electronic device with a QR code affixed thereto before depositing it in a repository.

FIG. 5 shows a system flow of an electronic device with a QR code being scanned by a scanner and being ultimately delivered back to the owner's residence.

FIG. 6 is a pictorial of a scanner for reading a barcode.

### DETAILED DESCRIPTION OF THE DRAWINGS

Reference will now be made in detail to the present preferred embodiments of the disclosure, examples of which are illustrated in the accompanying drawings.

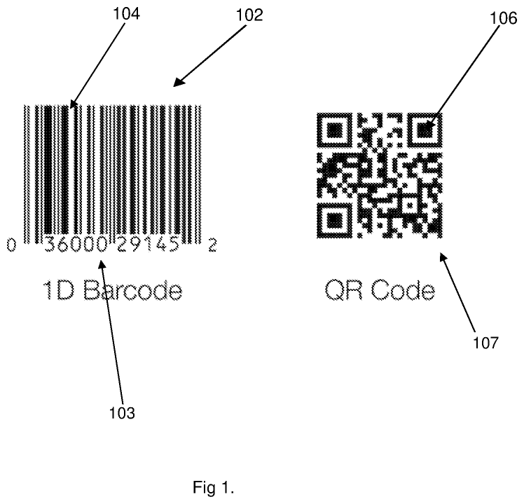

FIGS. 1 to 5 show a preferred embodiment of the system and method. The preferred elements of the system and their interrelationship are described below.

Referring to FIG. 1, a one dimensional bar code 102 is shown with numbers 103 beneath vertical lines 104, and a two dimensional QR code 106 with a quiet zone 107. Barcode 102 or QR code 106 may have the name and/or contact details for the business or other entity associated with the system or method, to which the lost electronic device should be returned, and any other instructions to guide finder to take the lost electronic device to a repository. For example, “If found, return to Australia Post”. QR code 106 may be static (with fixed information) or dynamic (with the possibility to be edited).

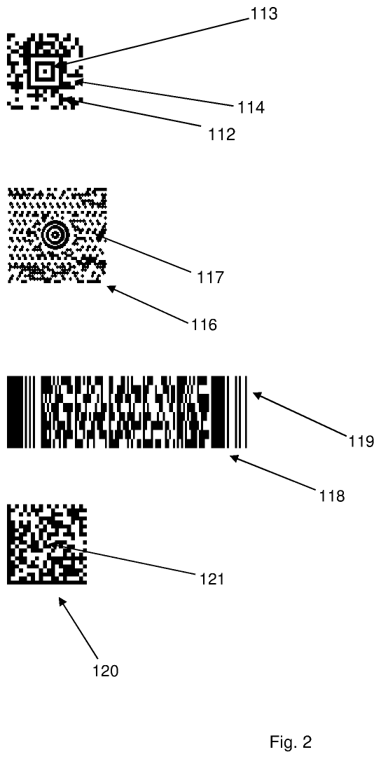

FIG. 2 shows five types of QR codes: Aztec code 112, MaxiCode 116, PDF417 118, and Semacode 120. The QR code may have finder code 113 or no recognisable finder code 121, squares 114 or a honeycomb pattern 117, and may be rectangular 119 in shape such that it resembles a barcode.

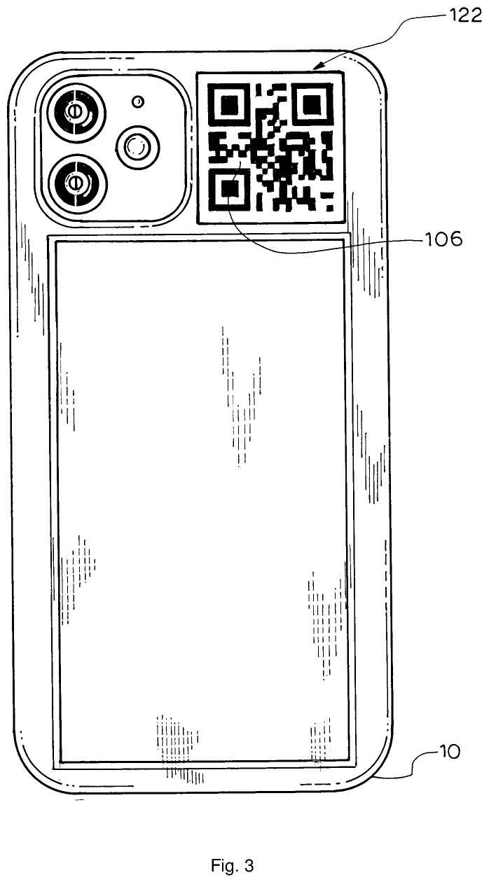

FIG. 3 shows a phone 10 with a QR code 106 attached to phone 10 by an adherent 122. The barcode or QR code may be a sticker, or adhered using a binding agent, glue, contact paper, laminate or other adherent; engraved or etched in electronic device; lasered onto electronic device; attached or imprinted onto electronic device in any suitable way.

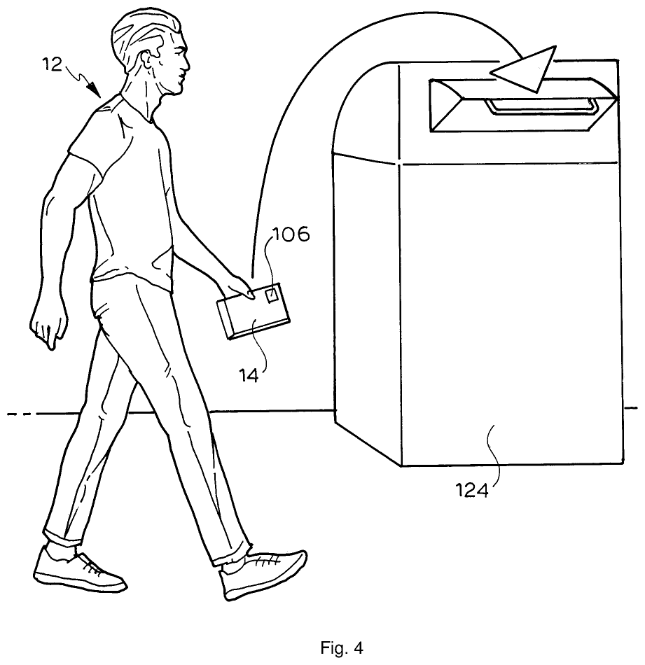

FIG. 4 shows a finder 12 holding an electronic device 14 with a QR code 106 before depositing it in a repository 124. The repository 124 may be a mailbox or a post office box or post office. Alternatively, it may be a service (gas) station, convenience store, courier delivery company, or specialised repository associated with the system or method.

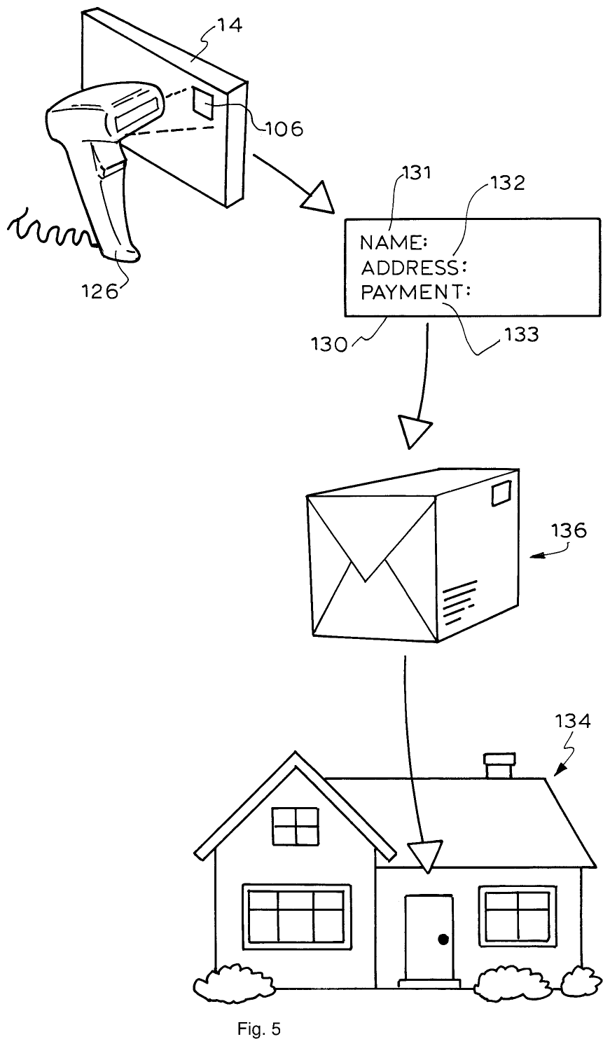

FIG. 5 shows a preferred system flow. An electronic device 14 with a QR code 106 is scanned by a scanner 126. The information retrieved by scanner 126 interacts with a database 130 to retrieve name 131, address 132 and payment 133 details associated with QR code 106, and electronic device 14 is returned to premises 134 at address 132 associated with QR code 106. The mode of delivery may be by post, such as a package 136 in the mail. Alternatively, it may be by personal pick-up at a location connected with repository, courier, marketplace delivery system such as a share ride service, or by drone. The premises 134 at address 132 associated with QR code 106 may be a house, post office box, place of business or nominated police station or library or service (gas) station or convenience store or any other address associated with QR code 106 as entered into database 130 by the person who purchased QR code 106 or amended by any person with access and authority to amend the information associated with QR code 106 from time to time. Name 131 may not be required or may be a pseudonym to preserve anonymity of the person associated with QR code 106, in accordance with privacy legislation or personal preference of the owner. Payment details 133 may be pre-paid details listing one or more of the following: the date QR code 106 was purchased, the credit towards the cost of delivery paid for and issued at the time of purchase of QR code 106, whether the credit has been used up by any prior delivery, and any date of expiration of the credit. Alternatively, payment details 133 may include the debit, credit, PayPal, Stripe or other payment platform details for the person associated with QR code 106, and an authority to charge the cost of delivery to the bank account connected to that debit, credit, PayPal, Stripe or other payment platform prior to delivery. Alternatively, payment details 133 may include an email address, phone number or other method of contact with instructions to contact the person associated with QR code 106 for payment once electronic device 14 is deposited by a finder to a repository, prior to delivery.

It will be appreciated that the steps described above may be performed in a different order, varied, or certain steps omitted entirely without departing from the scope of the present disclosure.

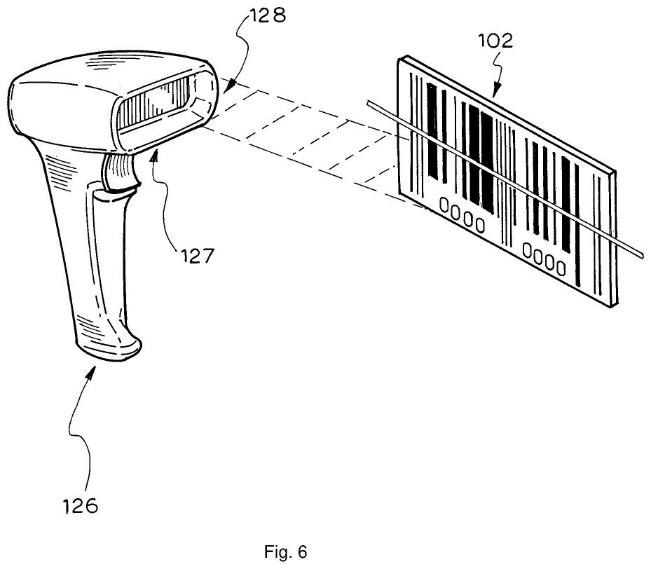

FIG. 6 shows scan reader 126 with a scan head 128, reading a barcode 102. Scanner 126 may be a phone camera, barcode reader or other scanner capable of reading coded data and outputting it via an output device, preferably with wireless communications capabilities.

The foregoing description is by way of example only, and may be varied considerably without departing from the scope of the present disclosure. The number of QR codes used, placement of the QR codes, shape of the QR codes may be varied without departing from the scope of the disclosure. For example, two or more QR codes 106 may be used, each linking to a different database 130 holding different information and requiring a different type of scanner 126 for increased security. As another example of helping ensure return to a genuine owner of the item, the method may include determining the presence of a supplemental device associated with the owner, the presence being within a predetermined radius of where the lost item was found, the supplemental device including a GPS chip for location determination, the method further including alerting the supplemental device upon determination of a match, and upon determination that the supplemental device is within the predetermined radius. The supplemental device may be a communications device such as a smartphone and/or tablet, or even smart eyewear.

The features described with respect to one embodiment may be applied to other embodiments, or combined with or interchanged with the features of other embodiments, as appropriate, without departing from the scope of the present disclosure.

The present disclosure in a preferred form provides the advantages of easy delivery of lost electronic devices by the finder to repositories that exist in multiple locations, making it more likely that finders will return items, return those items in a timely fashion, protect the finder and owner privacy and safety by avoiding disclosure of finder or owner personal information to the other, reduce the risk of extortion by the finder, and render it immaterial whether the lost electronic device is charged or not.

Other embodiments of the disclosure will be apparent to those skilled in the art from consideration of the specification and practice of forms of the embodiments disclosed herein. It is intended that the specification and examples be considered as exemplary only, with a true scope and spirit of the disclosure being indicated by the following claims.

1. A method for owner retrieval of a lost item, comprising:
inputting scanned code data into a database, the code data being from an affixable code-scannable tag affixed to the item;
determining the owner of the item from the code data by matching the code data with owner data in a database;
accessing an account associated with the owner that includes cost delivery costs of the item to an address associated with the owner of the item;
determining the presence of an owner smartphone or tablet within a predetermined radius of the lost item;
alerting the owner smartphone or tablet upon:
matching the code data with the owner data; and
determining that the smartphone or tablet is within the predetermined radius of the lost item; and
processing delivery of the item to the address in accordance with preconfigured delivery instructions associated with the owner of the item.

2. The method of claim 1 in which the affixable code-scannable tag is a QR code.

3. The method of claim 1, in which the item is at least one of a phone or computer.

4. The method of claim 1, wherein the code data excludes data associated with purchase price of the item.

5. (canceled)

6. An item retrieval system to facilitate delivery of a lost item to the address of the owner, comprising:
a code-scannable tag adhesively affixable to an item, the tag including a series of pre-configured shapes that when scanned by a code-scanner, are translated owner identification data; and
a database configured to record the owner identification data associated with the item, the owner identification data including an account that covers the cost of delivery of the item to the owner and the address of the owner; and
a processor configured to:
determine the presence of an owner smartphone or tablet within a predetermined radius of the lost item;
alert the owner smartphone or tablet upon:
matching the code data with the owner data; and
determining that the smartphone or tablet is within the predetermined radius of the lost item; and
process delivery of the item to the address in accordance with preconfigured delivery instructions associated with the owner of the item.

7. The system of claim 6 in which the code-scannable tag is a QR code.

8. The system of claim 6 in which the pre-configured shapes are numbers and/or letters.

9. The system of claim 8 in which the item is at least one of a phone or computer.

10. The system of claim 6, wherein the tag excludes data associated with purchase price of the item.

11-16. (canceled)

17. The system of claim 6, wherein the code-scannable tag includes a combination of symbols and numbers.

18. A method for owner retrieval of a lost item, comprising:
inputting scanned code data into a database, the code data being from a first affixable code-scannable label affixed to the item;
determining the owner of the item from the code data by matching the code data with owner data in a first database;
accessing an account associated with the owner that includes cost delivery costs of the item to an address associated with the owner of the item;
producing a second affixable code-scannable label linkable to a second database to increase security associated with the return of the lost item to the owner;
determining the presence of an owner smartphone or tablet within a predetermined radius of the lost item;
alerting the owner smartphone or tablet upon:
matching the code data with the owner data; and
determining that the smartphone or tablet is within the predetermined radius of the lost item; and
processing delivery of the item to the address in accordance with preconfigured delivery instructions associated with the owner of the item according to data scanned from at least one of the labels.

19. The method of claim 18, wherein the first affixable code-scannable tag is a QR code.

20. The method of claim 18, wherein the item is at least one of a phone or computer.

21. The method of claim 18, wherein the code data excludes data associated with purchase price of the item.
